(19) United States
(12) Patent Application Publication
(10) Pub. No.: US 2008/0202135 A1
(43) Pub. Date: Aug. 28, 2008

(54) Air conditioner energy saving unit and system using same

(76) Inventor: Danny Len Francis, Ben Lomond, CA (US)

Correspondence Address: MICHAEL A. GUTH, 2-2905 EAST CLIFF DRIVE, SANTA CRUZ, CA, 95062, US

(21) Appl. No.: 11/710,251

(22) Filed: Feb. 22, 2007

(51) Int. Cl. G05D 23/12; G05D 23/32

(52) U.S. Cl. 62/157; 236/1 C

(57) ABSTRACT

An energy saving apparatus and system for air conditioning and heating systems that is adapted for easy retrofit into already built rooms. A shut off apparatus for air conditioning systems utilizing standard dependable components. The apparatus may have a sensor for sensing open doors and windows and a timing portion that will shut off power to an air conditioner after a period of time.

### BACKGROUND

1. Field of the Invention

This invention relates to energy conservation, and more specifically to a system for conservation of energy when using air conditioners or heaters.

2. Description of Related Art

Air conditioning and heating systems are commonly used in both residential and commercial buildings and are commonly controlled by thermostats. However, people using these systems may leave doors or windows open for fresh air of other reasons, causing the air conditioning or heating system to operate at a nearly continuous level. This continuous operation of the air conditioning or heating system creates high electricity consumption because leaving a door or window open will prevent the interior environment from reaching the temperature setting for the thermostat.

This problem is especially acute in hotels and vacation rental facilities in which the occupants are not responsible for, nor aware of, the high electricity costs. Typically, each living unit in such facilities has a separate air conditioning unit, which is wall mounted or window mounted. Also, in many cases, the living unit may have a balcony for the use and enjoyment of the tenant. A real problem exists in hotels in that the tenant will have a separate air conditioning unit for their unit, and have set the thermostat down to a cool temperature, but then utilize the balcony while leaving the access door open. In such a case, the air conditioner will run non-stop, yet the cooled air will be lost to the exterior environment.

A variety of approaches have been used to stem this problem in new hotels, but these approaches typically are tied to new air conditioning and sensor systems, and to new building projects. The incremental cost increase for a new unit with these features may make some economic sense in new construction, but for the vast number of already built units the cost to completely replace the air conditioning unit with a new system is an insurmountable obstacle.

What is needed is an energy conserving system to reduce waste due to open doors and windows in living units with individual air conditioning systems that can be easily retrofitted into already built living units. What is needed is an energy conserving system that can be readily installed by a typical electrical contractor without special knowledge of digital systems and other complex technology.

### SUMMARY

An energy saving apparatus and system for air conditioning and heating systems that is adapted for easy retrofit into already built rooms. A shut off apparatus for air conditioning systems utilizing standard dependable components. The apparatus may have a sensor for sensing open doors and windows and a timing portion that will shut off power to an air conditioner after a period of time.

### BRIEF DESCRIPTION OF THE DRAWINGS

FIG. 1 is an illustration of a hotel balcony with a wall mounted air conditioner unit and a sliding door.

FIG. 2 is sketch of a wall mounted unit and its power plug.

FIG. 3 is a diagram of a system according to some embodiments of the present invention.

FIG. 4 is a diagram of a shut-off system according to some embodiments of the present invention.

### DETAILED DESCRIPTION

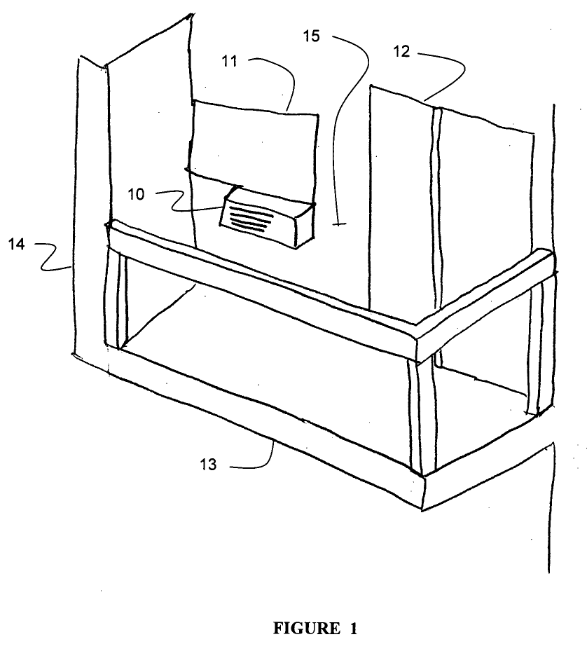

In some embodiments of the present invention, as seen in FIG. 1, a wall mounted air conditioning unit 10 is seen mounted against a wall 15. Typically a wall mounted air conditioning unit 10 is mounted exterior to a wall 15, perhaps on a balcony 13 that is part of a hotel 14 or other type of building. Of note is the eventuality that the air conditioning unit 10 may be one of dozens or hundreds at a particular site, so that a contemplated change by the owner incorporating an energy saving regime must be affordable due to the cost multiple all of these units entails. As well, simplicity of the change may be very important such that the changes can be implemented by a standard electrical contractor.

A window 11 and a sliding glass door 12 may be typical attributes of the dwelling unit into which the air conditioning unit 10 directs cooled air. Should the resident leave open the sliding glass door, as in the case of a hotel patron who wishes to utilize the view, the air conditioning unit may be faced with the problem of attempting to cool a room that is open to the hot air outside. This scenario results in high energy cost, and especially so when considering that a single building may have many units. In addition, often the user is not responsible for the energy costs, so there is no motivation to be frugal with regards to the energy drain from an incessantly running air conditioner. Although most of the following discussion is in regard to air conditioning units, the invention is not so limited. Heating units may also be addressed in the same manner as are air conditioners.

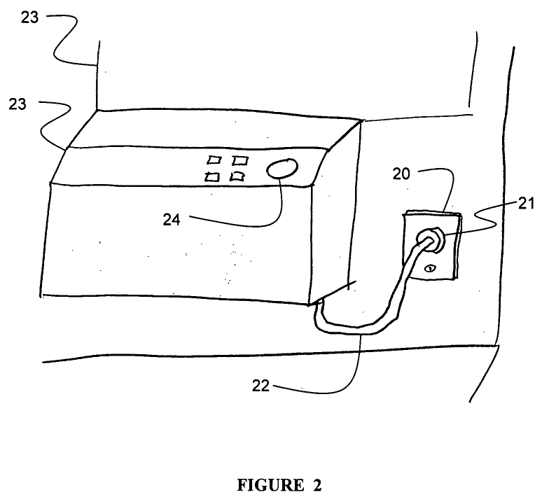

FIG. 2 illustrates an air conditioner 23 mounted in a wall just below a window 25. Typically, the air conditioner 23 will have a thermostat 24 which allows the user to set a target temperature for the room. The air conditioner 23 may have power cord 22 with a plug 21 that is connected to an outlet 20. In many cases, the air conditioner will use a 220V supply.

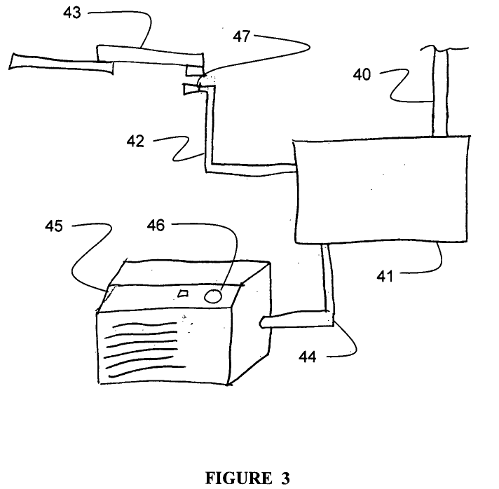

In some embodiments of the present invention, as seen in FIG. 3, an energy saving unit 41 is installed in line with the power input delivery 40 to the air conditioning unit 45. In some embodiments, the power input delivery 40 enters the energy saving unit 41 and continues on through a cord 44 to the air conditioning unit 45. In some embodiments, the input cord 44 maintains its original plug and plugs into an outlet on the energy saving unit. In some embodiments, the energy saving unit 41 has a plug on its input line 40 which plugs into the existing power outlet. In some embodiments, the energy saving unit 41 is co-located with the output plug in or on the wall of the room in which the air conditioning unit resides.

The energy saving unit 41 may be connected by wires 42 to a sensor switch 47 which senses whether a sliding door 43, or other door or window, is open. As the air conditioning unit 45 is set to a target temperature by the setting of its thermostat 46, an open door to a high temperature outside environment will keep the air conditioning unit 45 running indeterminably. The energy saving unit 41 utilizes a timing unit, or delay, which is triggered by the opening of the door 43. If the door has not been closed by the end of the time period specified by the timing unit, the power input 40 to the energy saving unit 41 will be interrupted, and no power will continue on through the input line 44 to the air conditioning unit 45. The opening, and subsequent closing, of the door by a user who merely goes through the door, will not keep the door open long enough to trigger the shut off in normal use. For example, the time period may be set for 2 minutes.

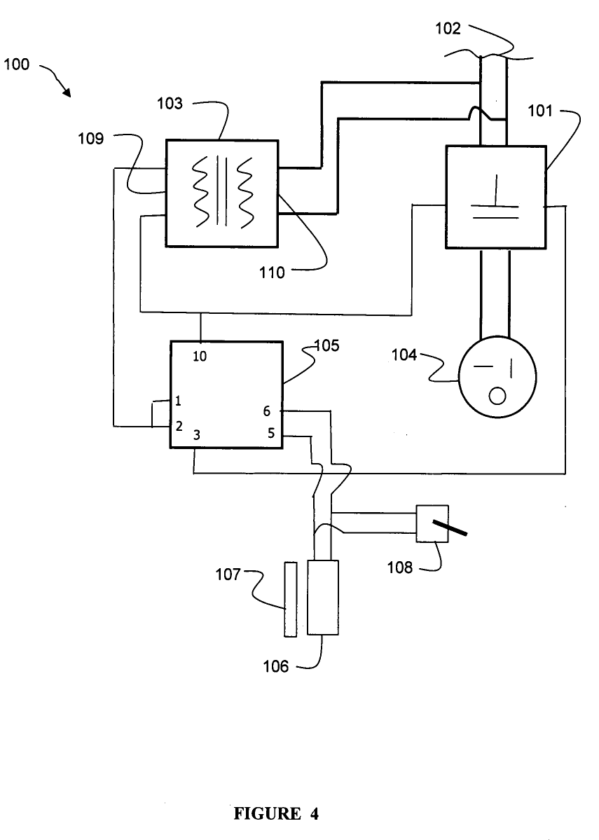

FIG. 4 illustrates a timing unit 100 according to some embodiments of the present invention. Full voltage input power 102 is delivered to the timing unit 100. Typically, this will be 220V input. The input power 102 is channeled to a normally open relay 101. The relay 101 may be a 2 pole definite purpose contactor in some embodiments. An example of such a contactor is made by Square D, with a model number 8910DP12V14. The full voltage input power is routed across the relay to an outlet 104 that supplies the air conditioning unit.

The full voltage input power 102 is split off to the line side of a transformer 103. The transformer may have a 220V primary and a 24V secondary. An example of such a transformer is a Dormeyer 4X745. The transformed voltage is then used in turn to power the other devices in the timing unit. In this way, the timing unit may be fully self-contained.

A relay and relay socket 105 are used as a timing unit adapted to determine the time period before which power is interrupted to the air conditioning unit. The numbers illustrated in FIG. 4 on the relay socket 105 correspond to a relay socket by Square D, model number 8501NR61, used with an electrical timing relay by Square D, model number 9050 JCK22V14. Typically, the timing unit will be reset upon the closing of the door or other item to which the switch has been affixed.

A magnetic switch may be used to sense if the door has been opened. Typically, part of the switch 106 will reside in one stationary location and a second part 107 will be mounted to the moving door. Also, a manual switch 108 may be used to override the switch if one chooses to include the functionality of an override. The manual switch may be mounted within a box enclosing the energy saving unit to restrict access to appropriate persons only.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A system comprising:
an air conditioning unit; and
an energy saving unit installed in line with the power delivery to said air conditioning unit, said energy saving unit comprising:
a switch adapted to sense an open door to the room cooled by said air conditioning unit,
a timing unit, said timing unit adapted to begin a countdown of a first time period upon the sensing of the opening of a first door by said switch,
wherein said energy saving unit will interrupt the power delivery to said air conditioning unit if said first door remains open until the end of said first time period.

2. The system of claim 1 wherein said energy saving unit will restore power delivery to said air conditioning unit upon the closing of said first door.

3. The system of claim 1 wherein said energy saving unit further comprises a relay, said relay in line with the power delivery to said air conditioning unit, said relay adapted to interrupt the power delivery to said air conditioning unit.

4. The system of claim 3 wherein said relay is triggered by said timing unit.

5. The system of claim 4 wherein said energy saving unit further comprises a transformer, said transformer adapted to provide power to said timing unit.

6. The system of claim 5 wherein said transform is adapted to provide power to said switch.

7. An energy saving unit comprising:
a switch adapted to sense an open door to the room cooled by said air conditioning unit,
a timing unit, said timing unit adapted to begin a countdown of a first time period upon the sensing of the opening of a first door by said switch,
wherein said energy saving unit will interrupt the power delivery if said first door remains open until the end of said first time period.

8. The unit of claim 7 wherein said energy saving unit will restore power delivery to said air conditioning unit upon the closing of said first door.

9. The unit of claim 8 wherein said energy saving unit further comprises a relay, said relay in line with the power delivery to said air conditioning unit, said relay adapted to interrupt the power delivery to said air conditioning unit.

10. The unit of claim 9 wherein said relay is triggered by said timing unit.

11. The unit of claim 10 wherein said energy saving unit further comprises a transformer, said transformer adapted to provide power to said timing unit.

12. The unit of claim 11 wherein said transform is adapted to provide power to said switch.

13. A system comprising:
a heating unit; and
an energy saving unit installed in line with the power delivery to said heating unit, said energy saving unit comprising:
a switch adapted to sense an open door or window to the room heated by said heating unit,
a timing unit, said timing unit adapted to begin a countdown of a first time period upon the sensing of the opening of a first door or window by said switch,
wherein said energy saving unit will interrupt the power delivery to said heating unit if said first door remains open until the end of said first time period.

14. The system of claim 13 wherein said energy saving unit will restore power delivery to said heating unit upon the closing of said first door.

15. The system of claim 13 wherein said energy saving unit further comprises a relay, said relay in line with the power delivery to said heating unit, said relay adapted to interrupt the power delivery to said air conditioning unit.

16. The system of claim 15 wherein said relay is triggered by said timing unit.

17. The system of claim 16 wherein said energy saving unit further comprises a transformer, said transformer adapted to provide power to said timing unit.
